(19) United States
(12) Patent Application Publication
(10) Pub. No.: US 2007/0140057 A1
(43) Pub. Date: Jun. 21, 2007

(54) Location and ranging system for divers

(75) Inventors: Winston S. Webb, Largo, FL (US); Nicholas A. Hartney, St. Petersburg, FL (US); Robert A. Schultz, Maderia Beach, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/300,744

(22) Filed: Dec. 15, 2005

(51) Int. Cl. G01S 3/802

(52) U.S. Cl. 367/118

(57) ABSTRACT

A location and ranging system for divers is disclosed, which indicates to a diver the position of, and range to, a boat (or other platform) with respect to the diver's current location. For example, a location and ranging system for divers is disclosed, which includes a transmitter, a receiver module, a display module, and a depth sensor integrated with the receiver module or display module. A diver can attach the display module to a convenient part of the body (e.g., the wrist), or a clipboard or buoyancy compensator. The transmitter is located at the diver's boat, and emits an encoded signal at a frequency suitable for transmission through water. The receiver module is carried by the diver (e.g., attached to the diver's SCUBA gear) and includes three receivers that independently receive the encoded signal from the transmitter. Logic circuitry in the receiver module triangulates the three received signals and derives the transmitter's direction. Also, based on the amplitude of one or more received signals, the logic circuitry can determine the distance to the transmitter. The display module includes a simple readout that displays the diver's depth, the distance to the transmitter/boat, and an arrow that points in the direction of the transmitter/boat. If the transmitter's antenna is submersed but near the water's surface, the logic circuitry in the receiver module can calculate the horizontal distance to the boat (e.g., parallel to the surface) using the depth information derived from the depth sensor and the known distance from the transmitter. Thus, with the direction and distance information directly at hand, the divers know how far they need to travel to reach the boat. As another example, a plurality of transmitters can be permanently located on the sea bed to form a guide path for divers. Also, a plurality of portable transmitters can be placed by divers at strategic locations in a cave, cavern or shipwreck. Consequently, the transmitters can be used to indicate an exit path for the divers, even if their guideline is broken or their visibility is obscured by silt.

### FIELD OF THE INVENTION

The present invention relates generally to the navigation field, and more specifically, but not exclusively, to a location and ranging system for divers.

### BACKGROUND OF THE INVENTION

Recreational and commercial divers often become disoriented or lost underwater and have to surface to find their boat or platform. Some divers periodically surface during their dives, in order to reorient themselves with respect to the locations of their boats. However, for deeper dives, periodically surfacing is not a safe option for divers because of the increased risk of their getting the bends. Also, in areas with strong or fast moving currents, divers can be swept down current unknowingly and end up much farther away from their boats than they intended. Even if the current is not strong, murky water can cause divers to become lost due to the lack of visibility. Essentially, if divers end up far away from their boats, they may simply have a long swim to get back. However, if a strong current is present, or the surface conditions are rough, the return swim can become very difficult if not impossible. Consequently, if there is no one on the boat that can pick them up, the divers can be come stranded and possibly lost at sea. Therefore, a pressing need exists for a system that can indicate to a diver the position and range of a boat or platform from the diver's current location. As described in detail below, the present invention provides such a system, which resolves the above-described diver orientation problems and other similar problems.

### SUMMARY OF THE INVENTION

The present invention provides a location and ranging system for divers, which indicates to a diver the position of, and range to, a boat (or other platform) with respect to the diver's current location. In accordance with a preferred embodiment of the present invention, a location and ranging system for divers is provided, which includes a transmitter, a receiver module, a display module, and a depth sensor integrated with the receiver module or display module. A diver can attach the display module to a convenient part of the body (e.g., the wrist), or a clipboard or buoyancy compensator. The transmitter is located at the diver's boat or platform, and emits an encoded signal at a frequency suitable for transmission through water. The receiver module is carried by the diver (e.g., attached to the diver's SCUBA gear) and includes three receivers that independently receive the encoded signal from the transmitter. Logic circuitry in the receiver module triangulates the three received signals and derives the transmitter's direction. Also, based on the amplitude of one or more received signals, the logic circuitry can determine the distance to the transmitter. The display module includes a simple readout that displays the diver's depth, the distance to the transmitter/boat, and an arrow that points in the direction of the transmitter/boat. If the transmitter's antenna is submersed but near the water's surface, the logic circuitry in the receiver module can calculate the horizontal distance to the boat (e.g., parallel to the surface) using the depth information derived from the depth sensor and the known distance from the transmitter. Thus, with the direction and distance information directly at hand, the divers know how far they need to travel to reach the boat. In accordance with a second embodiment of the present invention, a plurality of transmitters can be permanently located on the sea bed to form a guide path for divers. Also, for example, a plurality of portable transmitters can be placed by divers at strategic locations in a cave, cavern or shipwreck. Consequently, the transmitters can be used to indicate an exit path for the divers, even if their guideline is broken or their visibility is obscured by silt.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of an example location and ranging system for divers, which illustrates a preferred embodiment of the present invention;

FIG. 2 depicts a pictorial representation of an example receiver/display module, which can be used to implement the receiver unit and display unit in the example embodiment shown in FIG. 1; and

FIG. 3 depicts a pictorial representation of an example transmitter module, which can be used to implement the transmitter unit in the example embodiment shown in FIG. 1.

### DETAILED DESCRIPTION OF PREFERRED EMBODIMENT

With reference now to the figures, FIG. 1 depicts a pictorial representation of an example location and ranging system for divers 100, which illustrates a preferred embodiment of the present invention. For this example embodiment, system 100 includes a transmitter unit 102, a receiver unit 112, and a display unit 114. The transmitter unit 102 is submerged under the surface of the water (e.g., indicated by element 108) and co-located with a boat 106 or other type of diver related platform. The transmitter unit 102 is capable of transmitting a plurality of omni-directional, encoded signals (e.g., exemplified by the semi-circles 104a-104d) at a frequency suitable for transmission underwater. For example, transmitter unit 102 can be an audio frequency transmitter (e.g., similar to a sonar transmitter) that emits a series of timed audible “pings” (e.g., 10 audible pulses at 800 Hz). Each timed “ping” or pulse is encoded so that it has a unique identity and can be readily identified and distinguishable from other “pings” or pulses when received.

For this example embodiment, system 100 also includes a receiver unit 112 and a display unit 114, which are both carried by a diver 110. For example, receiver unit 112 can be temporarily attached to a diver's SCUBA gear (e.g., strapped to the diver's tanks 116), and display unit 114 can be attached to and worn on the diver's wrist. Receiver unit 112 operates at the same frequency (or frequencies) as transmitter unit 102, and is capable of receiving the plurality of encoded signals 104a-104d underwater and decoding them. For example, receiver unit 112 is an audio frequency receiver (e.g., similar to a sonar receiver) that is capable of receiving and decoding the transmitted series of timed audible “pings”.

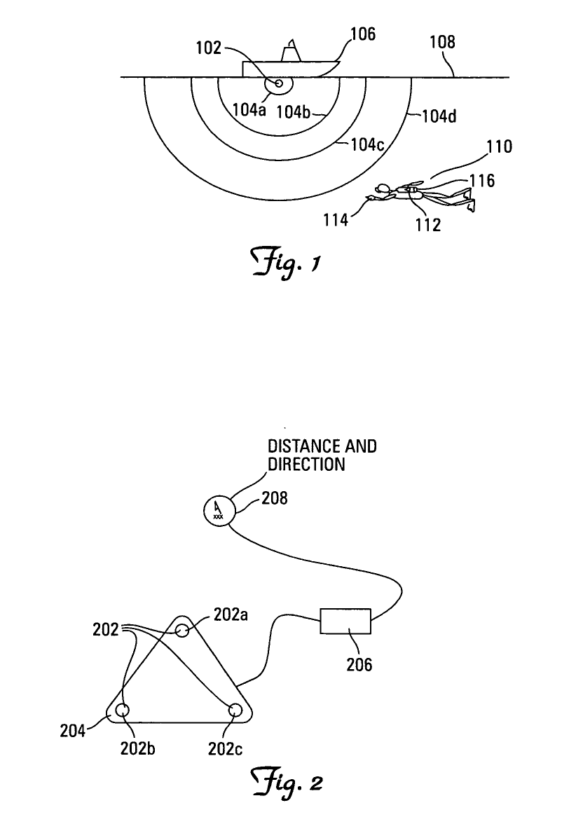

FIG. 2 depicts a pictorial representation of an example receiver/display module 200, which can be used to implement receiver unit 112 and display unit 114 in the example embodiment shown in FIG. 1. For this example embodiment, receiver/display module 200 includes a receiver mounting plate 204, a power supply and logic circuit 206, and a display 208. For example, receiver mounting plate 204 can be affixed by suitable straps to a diver's gear, and display 208 can be worn on the diver's wrist, attached to a clipboard or buoyancy compensator held by the diver, or attached somewhere convenient to the diver's body. For this example, the display 208 includes a readout that shows the distance (e.g., in meters or feet) from the diver to the transmitter and boat, and an indicator (e.g., arrow) that indicates the direction of the transmitter and boat. The diver can also carry a depth sensor (not shown), and the diver's depth information can be coupled to the logic circuit and used for determining the distance at the water's surface from the diver to the boat.

For this example embodiment, receiver mounting plate 204 includes a plurality of receivers 202 (e.g., three receivers 202a-202c) permanently attached to the receiver mounting plate 204 and at an equal distance from each other. The receiver mounting plate 204 is oriented with respect to the diver's body so that the corner of the mounting plate 204 nearest to receiver 202a is pointed toward the direction of the diver's head. Consequently, if an encoded signal is emitted from a transmitter that is located in the direction indicated by the arrow shown on display 208 (at 11 o'clock), then the wavefront of that signal would be received first by receiver 202a, second by receiver 202b, and third by receiver 202c. The received signals are decoded by the respective receivers 202a-202c and coupled to the logic circuitry section of power supply and logic circuit 206. Based on the timing of the received signals, the logic circuitry section can execute a suitable triangulation algorithm and thus determine the direction to the transmitter that emitted the encoded signals. The logic circuitry section couples the direction data to the display 208, which provides a visual indication of the direction information for the diver. Also, for this example embodiment, one of the receivers 202 (e.g., 202a) can be calibrated to associate a range of received signal strengths with a range of distances. Consequently, if that receiver detects a signal with a predetermined signal strength (e.g., −150 dbm), the logic circuitry section of power supply and logic circuit 206 associates that signal strength with a predetermined distance (e.g., 50 meters), and couples that distance information to the display 208. Display 208 provides a visual indication of that distance information for the diver.

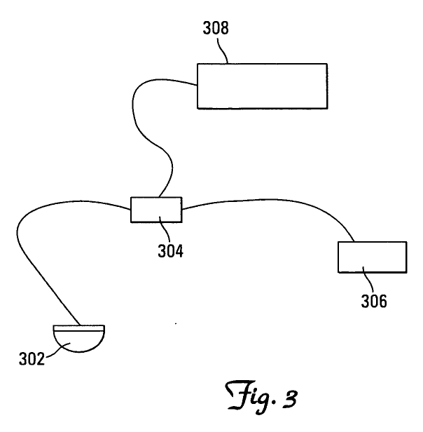

FIG. 3 depicts a pictorial representation of an example transmitter module 300, which can be used to implement transmitter unit 102 in the example embodiment shown in FIG. 1. For this example embodiment, transmitter module 300 includes a transmitter 302, a transmitter driver and logic circuit assembly 304, a power source and/or input connection 306, and a transmitter display and control panel 308. The transmitter 302 is submerged underwater, and the other components of transmitter module 300 can be located onboard the boat (e.g., 106) or other platform involved.

In operation, an operator can place the transmitter 302 underwater, and turn on the transmitter 302 by pressing appropriate switches on transmitter display and control panel 308. For example, the power source and/or input connection 306 can provide suitable power (e.g., 12V DC) to transmitter module 300 for onboard or portable use. Also, the operator can set the operating frequency and output power of transmitter 302. Responsive to inputs by the operator, the control panel sends suitable control signals to the transmitter driver and logic circuit 304. The logic circuit 304 sends coded signal information to the driver, which drives the transmitter 302 to transmit suitable encoded signals at a certain frequency and output power established by the operator. The transmitter 302 emits encoded audio signals, such as the signals 104a-104d shown in FIG. 1. The encoded audio signals are received and decoded by receivers 202a-202c in FIG. 2.

In accordance with the principles of the present invention, a location and ranging system for divers is provided, which enables a diver to view a display and determine the distance and range to the diver's boat or other platform. Also, a diver can place location and ranging system transmitters at strategic locations in a cave, cavern, shipwreck, or other similar underwater environment where murkiness and silt are of concern. The diver can view a display that directs the diver to each of the strategically located transmitters, which enables the diver to navigate successfully with minimal visibility within the underwater environment involved. Additionally, a pair of divers (e.g., buddy system) can each carry a location and ranging system transmitter unit and receiver unit, which enables these divers to view their respective displays and determine the direction and distance to each other. For example, the receiver units can be operated to receive and decode two different encoded signals at different frequencies (e.g., one from the boat's transmitter, and one from the other diver's transmitter).

It is important to note that while the present invention has been described in the context of a fully functioning location and ranging system for divers, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular location and ranging system for divers.

The description of the present invention has been presented for purposes of illustration and description, and is not intended to be exhaustive or limited to the invention in the form disclosed. Many modifications and variations will be apparent to those of ordinary skill in the art. These embodiments were chosen and described in order to best explain the principles of the invention, the practical application, and to enable others of ordinary skill in the art to understand the invention for various embodiments with various modifications as are suited to the particular use contemplated.

What is claimed is:

1. A location and ranging system for divers, comprising:
a transmitter unit, said transmitter unit operable to transmit a predetermined signal underwater;
a receiver unit, said receiver unit operable to receive said predetermined signal underwater, and determine a direction and a distance to said transmitter unit; and
a display unit coupled to said receiver unit, said display unit operable to display said direction and said distance.

2. The location and ranging system of claim 1, wherein said predetermined signal comprises an encoded audio frequency signal.

3. The location and ranging system of claim 1, wherein said predetermined signal comprises an encoded sonic ping.

4. The location and ranging system of claim 1, wherein said receiver unit comprises a plurality of audio frequency receivers.

5. The location and ranging system of claim 1, wherein said receiver unit comprises three receivers.

6. The location and ranging system of claim 1, wherein said direction is derived by a triangulation of said predetermined signal.

7. The location and ranging system of claim 1, wherein said distance is derived by at least one audio frequency receiver associated with said receiver unit.

8. The location and ranging system of claim 1, wherein said receiver unit is carried by a diver.

9. The location and ranging system of claim 1, wherein said display is attached to a diver's wrist.

10. The location and ranging system of claim 1, wherein said receiver unit is further operable to receive said predetermined signal and a second signal emitted by a second transmitter unit.

11. A location and ranging system for divers, comprising:
means for transmitting a predetermined signal underwater;
means for receiving said predetermined signal underwater;
means for determining a direction and a distance to said means for transmitting; and
means for displaying said direction and said distance.

12. The location and ranging system of claim 11, wherein said predetermined signal comprises an encoded audio frequency signal.

13. The location and ranging system of claim 11, wherein said predetermined signal comprises an encoded sonic ping.

14. A location and ranging method for divers, comprising the steps of:
transmitting a predetermined signal underwater;
receiving said predetermined signal underwater;
decoding said predetermined signal;
performing a triangulation based on said predetermined signal;
responsive to said triangulation, determining a direction value associated with said predetermined signal;
determining a distance value associated with said predetermined signal; and
displaying said direction value and said distance value.

15. The location and ranging method of claim 14, further comprising the steps of:
receiving a second predetermined signal emitted by a second transmitter unit;
decoding said second predetermined signal;
performing a triangulation based on said second predetermined signal;
determining a second direction value associated with said second predetermined signal, responsive to said triangulation based on said second predetermined signal;
determining a second distance value associated with said second predetermined signal; and
displaying said second direction value and said second distance value.

16. The location and ranging method of claim 14, further comprising the step of transmitting an encoded audio frequency signal from a second transmitter unit.

17. The location and ranging method of claim 14, wherein said predetermined signal comprises an encoded sonic ping.

18. A computer program product, comprising:
a computer-usable medium having computer-readable code embodied therein for configuring a computer processor, the computer program product comprising:
a first executable computer-readable code configured to cause a computer processor to cause a transmitter to transmit a predetermined signal underwater;
a second executable computer-readable code configured to cause a computer processor to cause a receiver to receive said predetermined signal underwater;
a third executable computer-readable code configured to cause a computer processor to decode said predetermined signal;
a fourth executable computer-readable code configured to cause a computer processor to perform a triangulation based on said predetermined signal;
a fifth executable computer-readable code configured to cause a computer processor to determine a direction value associated with said predetermined signal, responsive to said triangulation;
a sixth executable computer-readable code configured to cause a computer processor to determine a distance value associated with said predetermined signal; and
a seventh executable computer-readable code configured to cause a computer processor to display said direction value and said distance value.

19. The computer program product of claim 18, further comprising:
an eighth executable computer-readable code configured to cause a computer processor to cause said receiver to receive a second predetermined signal emitted by a second transmitter unit;
a ninth executable computer-readable code configured to cause a computer processor to decode said second predetermined signal;
a tenth executable computer-readable code configured to cause a computer processor to perform a triangulation based on said second predetermined signal;
an eleventh executable computer-readable code configured to cause a computer processor to determine a second direction value associated with said second predetermined signal, responsive to said triangulation based on said second predetermined signal;
a twelfth executable computer-readable code configured to cause a computer processor to determine a second distance value associated with said second predetermined signal; and
a thirteenth executable computer-readable code configured to cause a computer processor to display said second direction value and said second distance value.

20. The computer program product of claim 19, wherein said second direction value and said second distance value comprise a direction and distance to a diver.
